(19) United States
(12) Patent Application Publication
(10) Pub. No.: US 2025/0273870 A1
(43) Pub. Date: Aug. 28, 2025

(54) LENS ANTENNA FED BY A PHASED ARRAY

(71) Applicant: Hughes Network Systems, LLC, Germantown, MD (US)

(72) Inventors: Junyu Shen, Germantown, MD (US); Graham Taylor, Germantown, MD (US); George Eapen, Germantown, MD (US)

(21) Appl. No.: 18/585,461

(22) Filed: Feb. 23, 2024

(51) Int. Cl. H01Q 21/00; H01Q 25/00

(52) U.S. Cl. CPC H01Q 21/0031; H01Q 25/008

(57) ABSTRACT

Methods, systems, and apparatus for making and using a lens antenna fed by a phased array. In some implementations, a communication device includes an antenna system includes a lens antenna and a feed antenna. The lens antenna can be a gradient index lens having a substantially ellipsoidal shape, and having a plurality of layers that respectively have different dielectric constants. The feed antenna can include an array of antenna elements and can be spaced apart from the lens antenna. The communication device can include one or more processors configured to control excitation patterns for the antenna elements of the feed antenna to form beams directed at any of a range of spatial locations. The one or more processors can be configured to cause excitation patterns that concurrently excite multiple antenna elements of the feed antenna with different magnitudes and phase characteristics.

### BACKGROUND

The present specification relates to antennas in wireless communication systems, including lens antennas and techniques for feeding lens antennas.

Antennas are important elements of communication systems. In many cases, the properties of the antenna significantly affect the efficiency and throughput of the system. In satellite communication systems, satellite terminals can use antennas of different types to send and receive information to a satellite, such as a low-earth orbit (LEO) satellite or a geosynchronous (GEO) satellite.

### SUMMARY

In some implementations, a communication system includes a lens antenna that is fed by a phased array. For example, a satellite terminal can include an antenna system that includes a lens antenna fed by a phased array. The phased array allows different combinations of elements to be excited, and for the excitations to take place with different phase characteristics, in order to generate an electromagnetic wavefront with desired properties. For example, the excitation pattern of the phased array can be used to form a beam that is directed toward a satellite, in order to establish or maintain wireless communication with the satellite. The antenna system can be used to transmit and receive signals, e.g., microwave signals, to send and receive data in a satellite communication system.

Some microwave lens antennas are fed by collections of patch or horn antennas at or near the back surface of the lens, with the feeding antennas located on the focal plane or the surface formed by the focal points of the lens. In these arrangements, because the feeding antennas are at focal points, the ideal feed has a spherical wavefront emanating from that focal point. A horn or patch typically provides this spherical wavefront, so only one feed is active at a time. However, this arrangement limits the number of beams or scan directions that can used. For example, many traditional systems can only provide as many different beams or scan directions as there are feeding antennas (e.g., one beam or scan direction for each horn antenna). Antennas made this way do not allow a broad range of scan angles but are instead limited to a discrete set corresponding to the feeding antenna placements.

As discussed further below, the antenna system of the present document can feed a lens antenna with a phased array, which can emulate the fields of a horn or patch with a spherical wavefront emanating from any point behind lens. This results in the ability to direct a beam from the lens in a full, continuous scan volume, not just a few fixed directions. The elements of a phased array can be excited with phase differences set to cause interference that causes the overall wavefront to be curved, even though the phased array is planar. As an example, a region of elements in the phased array can be activated with varying levels of delay, such as delay amounts that decrease from the middle of the region toward the edges of the region. This type of excitation can result in a rounded or bulbous shaping of the wavefront, approximating a spherical wavefront.

The phased array can be positioned below the lens antenna, spaced apart from the lens antenna. The phased array is arranged so that the elements of the phased array are located between the lens antenna and a locus of focal points of the lens antenna, so the phased array can generate electromagnetic wavefronts that approximate spherical feed wavefronts that illuminate the lens antenna and originate from focal points of the lens antenna. This arrangement provides several advantages to the antenna system, including allowing the antenna system to fitting in a smaller volume and allowing a reduction in the size of phased array that is needed. This arrangement allows the phased array to feed the lens antenna even with a width that is significantly smaller than the width of the lens antenna. For example, the phased array may have a width that is between one third and two thirds of the width of the lens antenna. This can reduce the size and expense of the phased array while still providing appropriate efficiency for the antenna system.

The lens antenna of the antenna system can be a gradient index (GRIN) lens formed with multiple separately-formed components each having a different refractive index. Many conventional lens antennas are made through additive manufacturing, where the diffractive index gradient is formed by 3D printing layers of material having different dielectric constants or by 3D printing different densities of a single material. Neither of these approaches is suitable for large-scale production. In addition, the polymer materials that are used for additive manufacturing typically have high levels of electromagnetic loss (e.g., high loss tangents), which reduces efficiency. The lens of the present system can be formed using layers or shells that respectively have different dielectric constants, which have been formed separately by injection molding or other molding processes. The lens can be assembled by combining the layers, for example, in a press, with an adhesive, with mechanical fasteners, or other techniques. By separately molding the layers of the lens, materials with low electromagnetic loss can be used. In addition, different materials (e.g., different polymer formulations, different polymer densities, different polymer types) can be used for different layers to achieve the properties that are desired.

In some implementations, the phased array is located a fixed position with respect to the lens antenna, and changes to the excitation patterns applied to the elements of the phased array can form or move beams in a volume or range. In other implementations, the antenna system may be configured to move the phased array with respect to the lens antenna. For example, a motorized mount can be configured to rotate the phased array about an axis to achieve different positions with respect to the lens antenna. For some applications, only a portion of the area beneath the lens antenna needs to be excited at any given time, so the phased array can be moved to an appropriate position where it is needed. This allows a much smaller and more inexpensive phased array to be used, while still retaining the ability to form a beam over a wide range of spatial positions.

In one general aspect, a communication device includes: an antenna system including: a gradient index lens having a substantially oblate ellipsoidal shape, where the gradient index lens has a diameter and a central axis substantially perpendicular to the diameter, the gradient index lens having a plurality of layers that respectively have different dielectric constants, the layers being arranged to provide a progressively decreasing dielectric constant from an inner layer to an outer layer of the gradient index lens; and a feed antenna including a substantially planar array of antenna elements; the feed antenna is spaced apart from the gradient index lens along the central axis; and one or more processors configured to control excitation patterns for the antenna elements of the feed antenna to cause beams from the gradient index lens to be directed at any of a range of spatial locations, where the one or more processors are configured to cause the antenna elements to be excited with excitation patterns that concurrently excite multiple antenna elements of the feed antenna with different magnitudes and phase characteristics.

In some implementations, the plurality of layers of the gradient index lens include nested ellipsoidal shells formed of polymer materials.

In some implementations, the layers are formed of at least one of polyphenylene ether (PPE), polyether ether ketone (PEEK), or polypropylene copolymer (PPC).

In some implementations, the layers are formed of separately-molded components, and different layers are formed of different densities of polymer material.

In some implementations, the layers are formed of separately-molded components, and different layers are formed of different densities of polymer material.

In some implementations, the layers are bonded together using a bonding agent.

In some implementations, the bonding agent includes a pressure-sensitive adhesive or a matrix pre-impregnated with resin.

In some implementations, the communication device is a very small aperture terminal (VSAT) for communication in a satellite communication system, and the one or more processors are configured to adjust the excitation patterns for the feed antenna to detect or track a position of a satellite.

In some implementations, the communication device is configured to sweep a beam from the antenna system from a range of elevation from the central axis to an elevation from a horizontal plane of 30 degrees or less by changing the excitation pattern applied to the antenna elements in the array of the feed antenna.

In some implementations, the communication device is configured to sweep a beam 360 degrees about the central axis by changing the excitation pattern applied to the antenna elements in the array of the feed antenna.

In some implementations, the communication device includes a motorized mount configured rotate the array of the feed antenna about an axis of rotation, to rotate the array in a plane substantially perpendicular to the central axis. The array is positioned asymmetrically with respect to the axis of rotation, and the array is rotatable around the axis of rotation to change an azimuth of beams from the gradient index lens.

In some implementations, the lens has a height along the central axis that is between 40% and 60% of the diameter of the lens.

In some implementations, the array has a maximum width measured in a plane perpendicular to the central axis, and the maximum width is between 20% and 80% of the diameter of the lens.

In some implementations, the lens has a bottom surface that faces toward the array, and the array is spaced apart from the bottom surface of the lens along the central axis by a distance that is up to 50% of the diameter of the lens.

In some implementations, the communication device includes a data storage device storing a lookup table that specifies magnitude and phase characteristics for excitation patterns that, when applied to the array, respectively provide different beam orientations. The one or more processors are configured to (i) retrieve data from the lookup table that specifies an excitation pattern for a desired beam orientation and (ii) cause the antenna elements to be excited with the excitation pattern for the desired beam orientation.

In some implementations, the plurality of layers of the gradient index lens include three or more layers each having a substantially ellipsoidal shape, the three or more layers each have different sizes of exterior profiles, and the three or more layers each have interior cavities that allow the layers to nest together such that the cavities admit the layers formed of material with higher dielectric constant.

In some implementations, each of the plurality of layers has an ellipsoidal shape, such that the gradient index lens is formed of molded components that form nested ellipsoidal shapes.

In some implementations, the plurality of layers includes from 3 to 10 nested layers having different dielectric constants.

In some implementations, the plurality of layers includes from 4 to 8 nested layers having different dielectric constants.

In some implementations, the array includes (i) reception elements configured for receiving signals and (ii) transmission elements configured for transmitting signals, and the reception elements and the transmission elements are interspersed in the array.

In some implementations, the array is configured to concurrently transmit and receive signals using the antenna elements of the array.

In some implementations, the one or more processors are configured to drive excitation of the elements in the array to approximate a spherical wavefront of electromagnetic radiation from the array of elements.

In some implementations, the one or more processors are configured to excite the elements of the array with differing amounts of delay to vary a phase of excitation along the array.

In some implementations, the one or more processors are configured to shape the wavefront of radiation from the feed antenna by applying a delay to excitation of elements of the array aligned with a center axis of the lens antenna, and to incrementally decrease the amount of delay applied for elements of the array in a direction radially outward from the center axis.

In some implementations, the one or more processors are configured to excite the elements of the array with different patterns to generate electromagnetic wavefronts that respectively approximate wavefronts that would be produced by a horn antenna from different spatial positions with respect to the lens antenna.

In some implementations, the communication device includes a lookup table indicating excitation patterns corresponding to different beam positions, and the one or more processors is configured to use the lookup table to obtain excitation patterns to apply to the array.

In some implementations, the one or more processors are configured to track a position of a satellite as a relative position of the communication device and the satellite changes, and the one or more computers are configured to are adjust parameters of the excitation pattern for the array to change beam position to maintain communication with the satellite.

In some implementations, the communication device is a satellite terminal.

In some implementations, the layers have different dielectric constants, and the dielectric constants decrease monotonically layer by layer from an inner layer to an outer layer.

In some implementations, each of the layers has a substantially ellipsoidal outer profile, and from an inner layer to an outer layer the layers have increasingly larger outer profiles and progressively decreasing dielectric constants.

In some implementations, the layers include an inner layer having a dielectric constant of at least 11, one or more intermediate layers each having a dielectric constant that is less than 11, and an outer layer with a dielectric constant of 3 or less.

In some implementations, the layers include an inner layer having a dielectric constant between 10 and 15, one or more intermediate layers, and an outer layer with a dielectric constant between 1 and 4.

In some implementations, each of the layers is formed by components that fit together to form a substantially ellipsoidal outer profile, such that an assembly of the layers includes a series of ellipsoidal shapes from the inner layer to the outer layer and the dielectric constants of the layers progressively decreases from the inner layer to the outer layer.

In another general aspect, a method of creating a gradient index lens includes: molding a plurality of components that are sized to fit together to provide a series of layers, where the layers are respectively formed of materials with different dielectric constants such that different layers have different dielectric constants; fitting the components together to form an assembly, where the components are arranged in the assembly such that the layers decrease in dielectric constant from an inner layer of the assembly to an outer layer of the assembly; and bonding the components of the assembly together to form a gradient index lens having a substantially ellipsoidal shape.

In some implementations, molding the plurality of components includes forming the components by injection molding.

In some implementations, fitting the components together includes nesting the components together

In some implementations, the components are formed of at least one of polyphenylene ether (PPE), polyether ether ketone (PEEK), or polypropylene copolymer (PPC).

In some implementations, bonding the components of the assembly together includes applying at least one of heat or pressure to the assembly.

In some implementations, the method includes placing a bonding agent between the components in the assembly.

In some implementations, the bonding agent includes a matrix pre-impregnated with resin or a pressure-sensitive adhesive.

In some implementations, the bonding agent is placed at the interfaces of the components forming different layers.

In some implementations, bonding the components of the assembly together includes bonding the assembly in a hot press that applies pressure uniaxially on the assembly and heats the assembly.

In some implementations, the hot press applies pressure at a temperature between 100 degrees Fahrenheit to 600 degrees Fahrenheit.

In some implementations, the hot press applies pressure at a temperature between 300 degrees Fahrenheit to 600 degrees Fahrenheit.

In some implementations, the components are bonded using a contact adhesive, a thermoset adhesive, or a light-cured adhesive.

In some implementations, the gradient index lens has a height along a central axis and a diameter perpendicular to the central axis, and the height is between 25% and 75% of the diameter.

In some implementations, the gradient index lens has a height along a central axis and a diameter perpendicular to the central axis, and the height is between one third and two thirds of the diameter.

In some implementations, the gradient index lens has a height along a central axis and a diameter perpendicular to the central axis, and the height is between 40% and 60% of the diameter.

In some implementations, the components include an inner component and components that form a series of shells having increasingly larger exterior dimensions, including: one or more first components configured to form a layer around the inner component to form a first subassembly; one or more second components configured to form a layer around the first subassembly to form a second subassembly; and one or more third components configured to form a layer around the second subassembly.

In some implementations, fitting the components together includes: placing one or more first components around an inner component, such that the one or more first components substantially surround the inner component; placing one or more second components around the one or more first components, such that the one or more second components substantially surround the one or more first components that have the inner component within; and placing one or more third components around the one or more second components, the one or more first components and the inner component, such that the one or more third components substantially surround the one or more second components that have the one or more first components and the inner component within.

In some implementations, the first subassembly is formed with a bonding agent placed between the inner component and the one or more first components, the second subassembly is formed with bonding agent placed between the first subassembly and the one or more second components, and the third subassembly is formed with bonding agent placed between the second subassembly and the one or more first components.

In some implementations, the inner component, the first subassembly, the second subassembly, and the third subassembly each have a substantially ellipsoid exterior.

In some implementations, the dielectric constant decreases through the assembly, layer by layer, outward from a center of the assembly both along a central axis of the assembly and radially outward from the central axis.

In some implementations, the components fit together to form layers that each have a substantially ellipsoidal outer profile, such that in the assembly is a series of ellipsoidal shapes from the inner layer to the outer layer and the dielectric constants of the layers progressively decreases from the inner layer to the outer layer.

In some implementations, each of the layers has a substantially ellipsoidal outer profile, each has increasingly large outer profile and progressively decreasing dielectric constant

In some implementations, each of the layers has a substantially ellipsoidal outer profile, and from an inner layer to an outer layer the layers have increasingly larger outer profiles and progressively decreasing dielectric constants.

In some implementations, the layers include an inner layer having a dielectric constant of at least 11, one or more intermediate layers each having a dielectric constant that is less than 11, and an outer layer with a dielectric constant of 3 or less.

In some implementations, the layers include an inner layer having a dielectric constant between 10 and 15, one or more intermediate layers, and an outer layer with a dielectric constant between 1 and 4.

Other embodiments of these and other aspects described herein include corresponding systems, apparatus, and computer programs, configured to perform the actions of the methods, encoded on computer storage devices. A system of one or more computers and/or communication devices can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a communication system that includes a terminal that has a lens antenna that is fed by a phased array.

FIG. 2A is a top view of an example lens antenna.

FIG. 2B is a side view of the example lens antenna.

FIG. 3 is a perspective view of the example lens antenna and an example phased array.

FIGS. 4A and 4B show example responses from the lens antenna in response to excitations from different portions of the phased array.

FIG. 5A is a graph that shows directivity for two different angled scan patterns.

FIG. 5B shows examples of excitation magnitudes and excitation phase for creating the scan patterns of FIG. 5A.

FIG. 6 is a diagram that shows example spatial relationships between an example lens antenna and phased array.

FIGS. 7A and 7B illustrate examples of element distributions in a phased array.

FIGS. 8A and 8B show examples of different sizes and shapes of phased arrays with respect to the lens antenna.

FIG. 9A is a diagram showing a side view of an example phased array and a motorized mount configured to rotate the phased array to change its position relative to the lens antenna.

FIGS. 9B-91 are diagrams that illustrate examples of different shapes and sizes of phased arrays that can be used.

FIG. 10A is diagram showing a side view of another example phased array and a motorized mount configured to rotate the phased array to change its position relative to the lens antenna.

FIGS. 10B-101 are diagrams that illustrate examples of different shapes and sizes of phased arrays that can be used.

Like reference numbers and designations in the various drawings indicate like elements.

### DETAILED DESCRIPTION

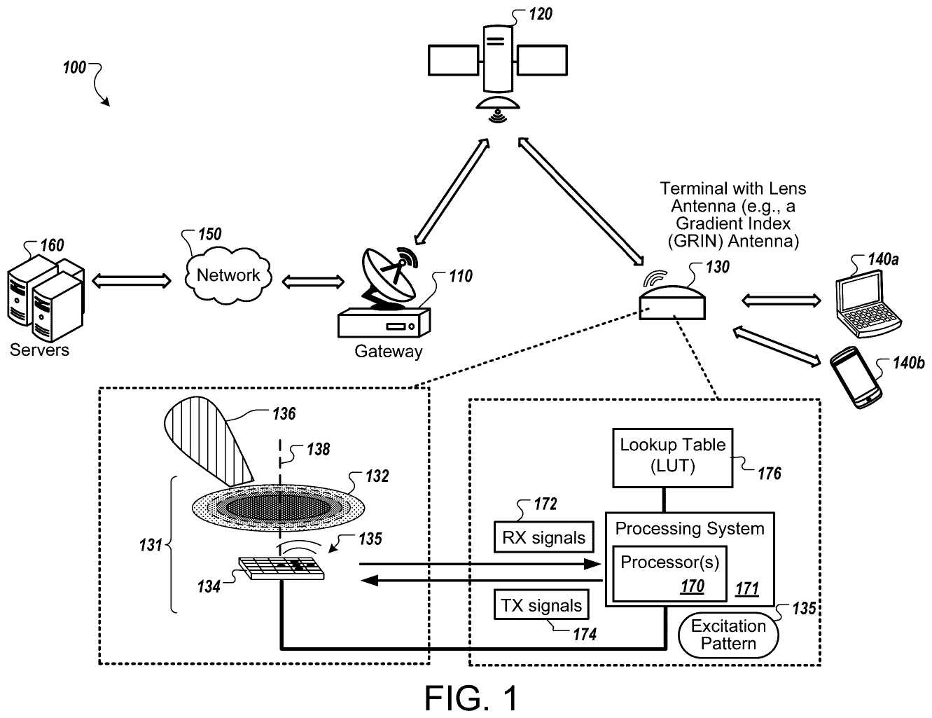

FIG. 1 is a diagram showing an example of a satellite communication system 100. The system 100 includes a satellite gateway 110, a satellite 120, a satellite terminal 130 and user devices 140a, 140b. The system 100 provides a satellite communication link with bi-directional communication, using wireless communication between the gateway 110 and the satellite 120, and wireless communication between satellite 120 and the terminal 130. Through the satellite link, the user devices 140a, 140b can receive forward channel data, such as data that one or more servers 160 provide through a network 150, such as the Internet or a core network for telecommunications (e.g., a core network for 4G or 5G communications). The satellite link also enables the user devices 140a, 140b to send reverse channel data out through the network 150.

The terminal 130 can be a very small aperture terminal (VSAT). The terminal 130 includes an antenna system 131 that includes a lens 132 that is fed by emissions of a phased array 134 that acts as a feed antenna for the lens 132. The phased array 134 can be driven with excitation characteristics calculated to simulate a spherical wavefront, such as would be produced from a horn antenna at a particular location, even though the phased array 134 is a substantially planar array of antenna elements. This allows the phased array 134 to feed the lens 132 efficiently with a small footprint and to sweep a beam over an area much more quickly and precisely than can be done by mechanically positioning a horn antenna. In addition, the phased array 134 permits a wide variety of beam positions, including potentially beam positions along continuous range, as well as a variety of different beam geometries, including the formation of multiple simultaneous beams.

The terminal 130 includes a processing system 171 that determines and sets the excitation pattern 135 to be used to excite the antenna elements of the phased array 134, in order to form a beam 136 with the desired properties (e.g., size, shape, spatial orientation, etc.). The excitation pattern 135 can specify parameter values such as a subset of antenna elements of the phased array 134 to be excited (e.g., locations on the phased array 134 to be activated), phase relationships among the excitations of the antenna elements in the subset, magnitudes of excitations with which to drive the antenna elements in the subset, and so on. The processing system 171 also generates and sends signals representing data to be transmitted (e.g., TX signals 174) based on data sent by the user devices 140a, 140b. The processing system 171 receives from the antenna system 131 signals representing received information (e.g., RX signals 172) and sends data received to the user devices 140a, 140b. The processing system 171 includes one or more processors 170, such as microcontrollers, digital signal processors, central processing units (CPUs), etc. Other components of the terminal 130 that are involved in processing signals to transmit, receive, and process signals are not shown, such as a memory and radiofrequency signal chains (e.g., amplifiers, downconverters, upconverters, synthesizers, digital-to-analog converters (DACs), analog-to-digital converters (ADCs), and so on).

To select the excitation pattern 135 to apply to the phased array 134, the processing system 171 can access data in a lookup table 176 that represents excitation patterns corresponding to different beam orientations. The lookup table 176 can be stored in a data storage device of the processing system 171, such as a non-volatile memory. The data in the lookup table can specifies magnitude and phase characteristics for excitation patterns that, when applied to the array, respectively provide different beam orientations. The one or more processors 170 can retrieve data from the lookup table that specifies an excitation pattern for a desired beam orientation, and then cause the antenna elements to be excited with the excitation pattern for the desired beam orientation.

As an example, the lookup table 176 can include entries representing dozens, hundreds, or thousands of different beams that can be formed. These different beams can have different combinations of properties, such as different beam orientations and beam shapes. The phased array 134 can be capable of forming of beams at any position along a region of space, including all around the central axis 138. Nevertheless, using pre-computed excitation patterns from the lookup table 176 can reduce the processing load in the terminal 130 and can allow excitation patterns to be determined very quickly. To determine the excitation pattern to use, the processor(s) 170 can determine a spatial position for a beam (e.g., an azimuth angle and elevation angle) and use these angles as a key to retrieve a corresponding stored excitation pattern that is configured to generate a beam at that position. Each stored excitation pattern can indicate properties such as a subset of the antenna elements in the phased array 134 to excite, magnitudes (or relative magnitudes) for exciting the antenna elements in the subset, phase values or phase differences for exciting the antenna elements in the subset, and so on. Once the processing system 171 determines the excitation pattern 135, the processing system 171 applies the parameter values that define the excitation pattern 135 by activating the subset of antenna elements according to those parameter values. In some implementations, the processing system 171 can include equations or functions to calculate excitation patterns that yield different beam properties, in addition to or instead of using pre-computed excitation patterns from the lookup table 176.

The processing system 171 can change the excitation pattern 135 used to change the orientation or other properties of the beam 136 that is formed. For example, the excitation pattern that is applied can be changed, e.g., moved around the phased array 134, to move the beam to scan a region or range of positions. As another example, once a connection to the satellite 120 is established, the processing system 171 can update the excitation pattern 135 to track the position of the satellite 120 in order to maintain the satellite communication link.

In some implementations, the antenna is capable of forming multiple beams concurrently. For example, certain excitation patterns can be calculated to concurrently provide beams in multiple predetermined directions.

In further detail, the lens 132 can be a gradient index (GRIN) antenna, having a gradient in the refractive index or dielectric constant of the material forming the lens 132. Typically, the refractive index is the square root of the dielectric constant. For example, the lens 132 can have a first dielectric constant at the center, and then have a gradually or progressively (e.g., incrementally) decreasing dielectric constant moving toward the exterior of the lens antenna. The lens 132 can have a central portion with the highest dielectric constant and then include material with progressively decreasing dielectric constant in a direction along a central axis 138 of the lens 132 as well as radially outward from the central axis 138.

As an example, the lens 132 can be an approximated or modified version of a Luneburg lens (e.g., a spherically symmetric gradient-index lens), which is one type of GRIN lens. A Luneburg lens is typically spherical, and although the terminal 130 can use a spherical lens antenna, it is often beneficial to use a version in which the dimension of the lens 132 is reduced along the central axis 138, so the resulting profile of the lens 132 is compressed or shortened compared to the height in a spherical shape. This results in an overall shape of the lens 132 that is a substantially oblate ellipsoidal shape. The shape retains much of the transmission efficiency of the Luneburg design, while significantly reducing the size of the lens 132 and thus the terminal 130 as a whole. The amount of compression of the Luneburg shape can be set to achieve a desired tradeoff between size and efficiency. For example, in some implementations, the height of the lens 132 along the central axis 138 is between 20% and 80% of the diameter perpendicular to the central axis 148, or more specifically between 40% and 60%. As additional examples, the height can be, for example, approximately 25%, 33%, 40%, 50%, or 60% of the diameter perpendicular to the central axis 138, depending on the power levels needed, the efficiency needed, and size constraints for the terminal 130.

The lens 132 can also differ from an ideal Luneburg lens in the implementation of the refractive index gradient or dielectric constant gradient. For example, the lens 132 can be formed of a series of layers of materials with different dielectric constants, where each different layer or different material provides a different dielectric constant. As a result, the dielectric constant decreases progressively from the center of the lens 132 to the exterior of the lens 132 in steps, each layer or component providing an additional step toward the final dielectric constant at the exterior.

The lens 132 can be formed of multiple curved components, such as injection-molded shells with increasing size from the interior to the exterior, where the components that nest together or fit concentrically over each other to form the lens 132. Using separate injection-molded plastic components to achieve the regions of differing dielectric constant can provide higher efficiency and higher performance of the resulting lens 132 compared to lenses formed with other techniques. For example, some GRIN lens are created using additive manufacturing (e.g., 3D printing), but the constraints of the manufacturing technique limit the materials that can be used as well as the accuracy of the dielectric constants that can be achieved. For example, the polymers that are suitable for 3D printing typically have a loss tangent (e.g., degree of electromagnetic wave absorption by the dielectric material) of 0.03 or higher. By contrast, molded components that together form the gradient structure of the lens 132 allows the use of materials that have a much lower loss tangent than the materials that are available for 3D printing, in some cases, ten times lower or more. This, in turn, allows the lens 132 to have a much higher sensitivity and power efficiency than designs restricted to 3D printed materials. In addition, by molding separate components to form different regions of the lens 132, the accuracy of the dielectric constant can be very accurately set for that region, which also contributes to high efficiency. The lens 132 can make use of different materials, or different types of structures of those materials, for different layers or components, which greatly increases the versatility in setting the dielectric gradient. Thus, even with the gradient is provided with stepped changes in dielectric constant layer by layer, the use of molded layers to provide the gradient improves efficiency through, for example, the use of low-loss materials not usable in additive manufacturing, the ability to precisely shape each layer, and the ability to accurately set the dielectric constant at each layer through the materials and structures determined individually for each layer.

The lens 132 can be formed of three or more layers or steps having different dielectric constants, e.g., three or more layers so that one or more intermediate layers are located between the interior-most component to the exterior-most component providing the gradient. In some cases, index gradient of the lens 132 can be formed using 4, 5, 6, 7, 8, 9, or more different layers or different dielectric indices. The layers or components can be molded separately and then coupled together or bonded together through any of various techniques, including, for example, a bonding agent such as an adhesive (e.g., a pressure sensitive adhesive, a contact adhesive, a hot-melt adhesive, an epoxy, thermoset polymer), and so on. In some implementations, mechanical or physical surface treatments can be applied to roughen or otherwise add texture to the surfaces of molded components to enhance adhesion when using a bonding agent. As another example, components can be bonded using thermoplastic welding or bonding. Other techniques for coupling the layers include wrapping tape around some or all of the assembly, an overwrap or heat-shrinking wrap, fasteners, mechanical clips or locking mechanisms. As another example, the components or layers can be formed sequentially by over-molding of one layer or component onto or around inner layers, potentially with holes or cavities defined to allow material of the subsequently overmolded layer to enter and lock the layers together.

The material of the various layers or component shells in the lens 132 can be polymers such as polyphenylene ether (PPE) (sometimes also referred to as polyphenylene oxide (PPO)), polyether ether ketone (PEEK), polypropylene copolymer (PPC). Different formulations of these materials can be made to achieve different dielectric constants by changing various properties, such as the blend or density of material. As an example, PPE formulations can have properties that range from at least (i) a dielectric constant (at 2.4 GHZ) of approximately 2.5 and a loss tangent (at 2.4 GHz) of 0.0009 at a density of approximately 1.05 g/cm³ to (ii) a dielectric constant (at 2.4 GHZ) of approximately 12.0 and a loss tangent (at 2.4 GHZ) of 0.0010 at a density of approximately 2.40 g/cm³. This shows that PPE has the beneficial property of having a consistently low loss tangent over a significant range of values for the dielectric constant and density. Some PPE formulations can provide dielectric constant of 20 or higher. As another example, PEEK formulations can have properties that range from at least (i) a dielectric constant (at 2.4 GHZ) of approximately 7 and a loss tangent (at 2.4 GHZ) of 0.0024 at a specific gravity of approximately 1.9 g/cm³ to (ii) a dielectric constant (at 2.4 GHZ) of approximately 12 and a loss tangent (at 2.4 GHZ) of 0.0027 at a density of approximately 2.40 g/cm³. PEEK thus also demonstrates a range of dielectric constants and a stable, low range of loss tangent values over the range of dielectric constants.

These example materials PPE, PPEK, and PPC have low loss tangents that are stable across significant ranges of temperature and remain small and with limited variation across frequency bands often used for satellite communications (e.g., L-band, S-band, C-band, X-band, Ku-band, K-band, and Ka-band). In some implementations, the lens 132 is designed to operate at approximately 19 GHz. These and other polymers can have their properties adjusted by using different blends of materials and by incorporating different additives and fillers at various concentrations.

The phased array 134 has multiple antenna elements that can be selectively excited to adjust the directional response of the antenna system 131. For example, terminal 130 can set and vary excitation of different antenna elements of the phased array 134 to form a beam 136 in a desired spatial direction. The terminal 130 can change the excitation pattern of the phased array 134, for example, by changing one or more parameters such as the set of antenna elements activated, the magnitude of excitation of individual elements, and the phase of excitation of individual antenna elements. Multiple elements of the phased array 134 can be activated concurrently to form an excitation pattern 135 that forms the beam 136 oriented in the desired direction. The phased array 134 can be a substantially planar array, with multiple antenna elements along each of two dimensions, such as in a 2D grid of antenna elements.

By adjusting the excitation patterns of the phased array 134, the terminal 130 can use the antenna system 131 to maintain or change the orientation of the beam 136. This can be useful to track or follow the satellite 120 over time, to maintain a connection over time as the terminal 130 and/or the satellite 120 move. For example, the terminal 130 may be located in or mounted on a vehicle, and movement of the vehicle may cause the position of the terminal 130 relative to the satellite 120 to change. Similarly, the satellite 120 may move, especially if the satellite 120 is a low-earth orbit (LEO) satellite. Changing the excitation pattern 135 and thus the resulting direction of the beam 136 can also be used to scan an area or range of range of angles positions, such as to find a satellite and establish a connection.

In some implementations, the antenna system 131 allows adjustment to the orientation of the beam 136 while a static positioning of the phased array 134 with respect to the lens 132 is maintained. For example, the phased array 134 is arranged so that, without physically moving the phased array 134 relative to the lens 132, changing the excitation pattern 135 can set the beam 136 to be positioned at, or scanned along, any angular position in a 360° range around a central axis 138 of the lens 132. For example, if the central axis 138 is oriented vertically, the beam 136 can be scanned 360° along an azimuth circle. Changing the excitation pattern 135 can also change the elevation (e.g., altitude), which refers to the angle of the beam 136 from the horizon (e.g., toward or away from the central axis 138 of the lens 132). For example, if the central axis 138 is oriented vertically, the elevation angle can be changed from substantially 0° (e.g., horizontal or perpendicular to the central axis 138) to 90° (e.g., vertical or along the central axis 138), so the beam 136 can be steered along a three-dimensional area that is substantially hemispherical.

In practical applications, the center of the beam 136 may not need to cover an entire hemispherical range or orientations. For example, the elevation range covered may not reach (and may not need to reach) 0°, but instead the center of the beam may be electronically steerable along an elevation range that starts at, for example, 10°, 15°, 20°, etc. instead. As another example, for use with geosynchronous (GEO) satellites (which by their positions will not be directly over the terminal 130), the terminal 130 would not need to steer a beam at an elevation of 90°, and so may be designed to have a lower maximum elevation, such as 80°, 70°, 60°, etc. As an example, in some implementations, terminals designed for use in the continental United States to communicate with GEO satellites can be configured to operate at elevation angles from 15° to 85° and may not need to operate outside this range. As discussed below, various different geometries and placements of the phased array 134 can be used, and designs with a narrower range of elevations at which the center of the beam 136 can be placed can reduce size and cost of the terminal 130, while still providing fine-grained beam steering in the angle ranges needed for a particular application.

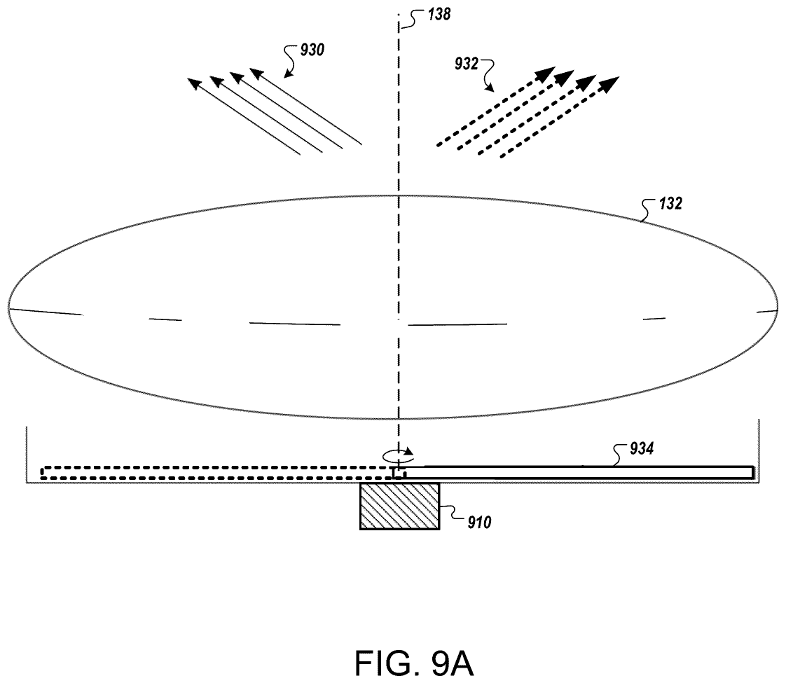

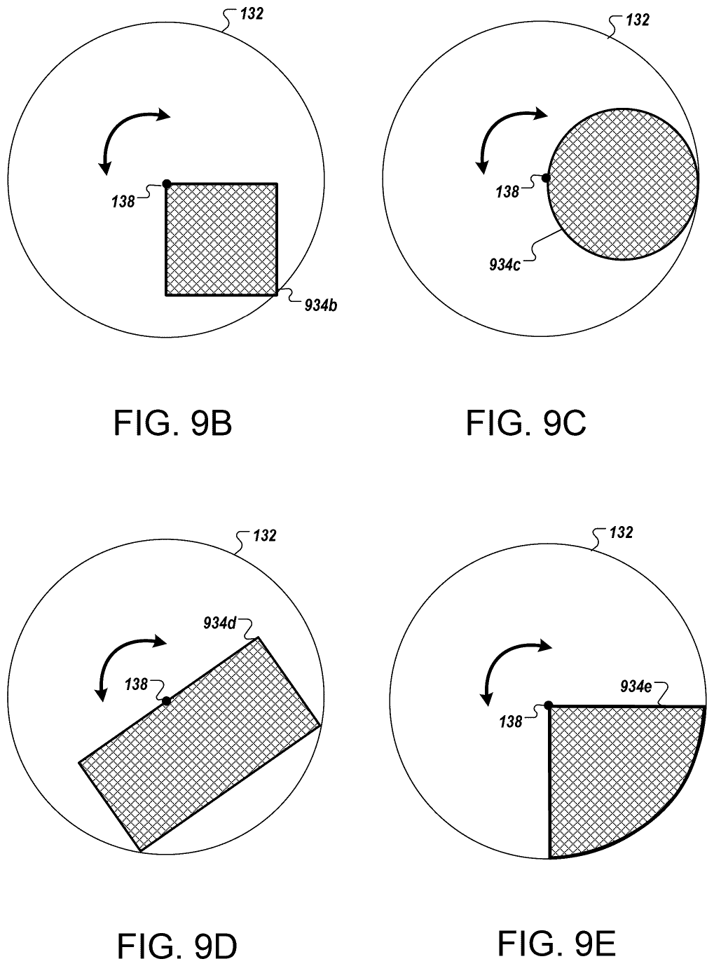

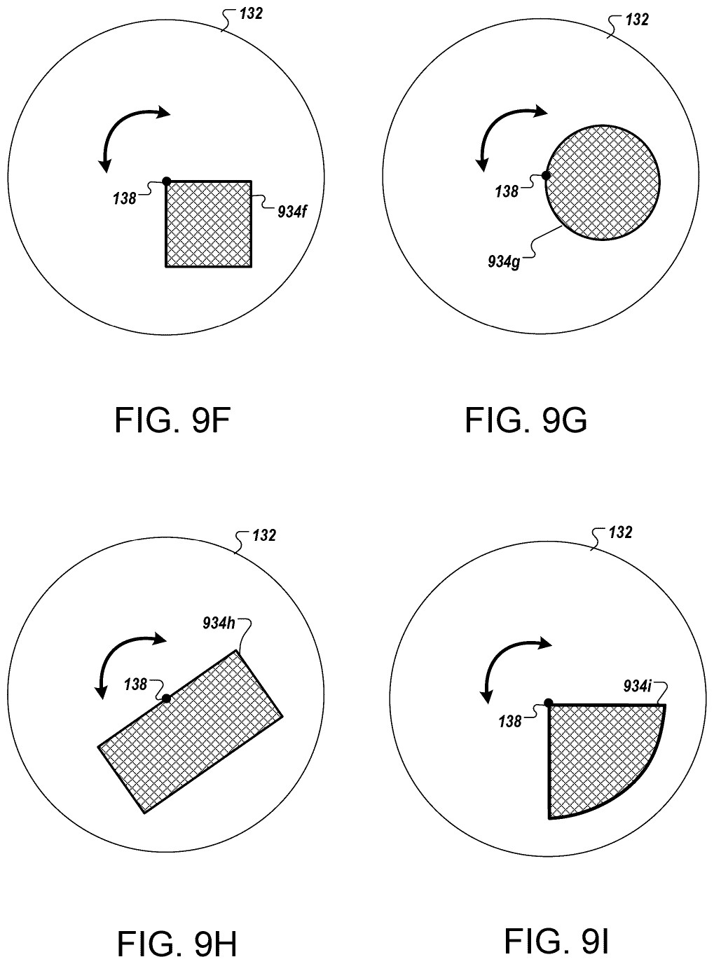

In some implementations, the terminal 130 may include a motorized system to adjust the position of the phased array 134 with respect to the lens 132. For example, as discussed further with respect to FIGS. 9A to 101, a motor can be coupled to rotate the phased array around the central axis 138 (e.g., in a plane). When the phased array 134 is offset or asymmetrically placed with respect to the central axis 138, this rotational movement can allow a much small phased array to achieve a range of beam orientations that matches or approximates a much larger phased array. For example, instead of using a phased array 134 that spans both sides of the lens 132 equally across the central axis 138, a phased array 134 of approximately half the size or less can extend predominately to one side of the central axis 138, but can be mechanically rotated to different positions to place antenna element excitations in space where needed to produce desired beam orientations. The phased array 134 is one of the components of the terminal 130 with the highest cost, and so reducing the size of the phased array 134 in this way can significantly reduce the cost of the terminal 130 while preserving the ability to form beams covering all azimuths (e.g., 360° around the entire central axis 138).

The phased array 134 can be one of any of various types of arrays, including, for example, a passive electronically scanned array (PESA), an active electronically scanned array (AESA), a hybrid beam forming phased array, or a digital beam forming (DBF) array.

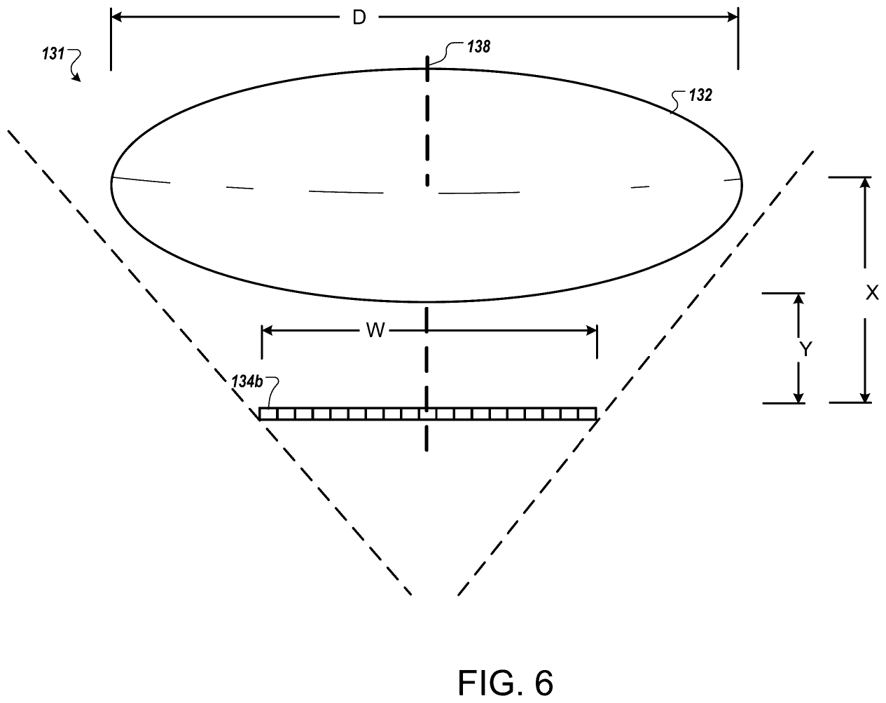

The antenna system 131 can position the phased array 134 below the lens 132 and spaced apart from the lens 132 along the central axis 138. By spacing apart the phased array 134 from the lens 132, a smaller phased array 134 can be used to provide wavefronts that simulate transmission from different focus positions of the lens 132. This arrangement allows the phased array to feed the lens antenna even with a width that is significantly smaller than the width of the lens antenna, as discussed further below with respect to FIG. 6. For example, the phased array may have a width that is between one third and two thirds of the width of the lens antenna.

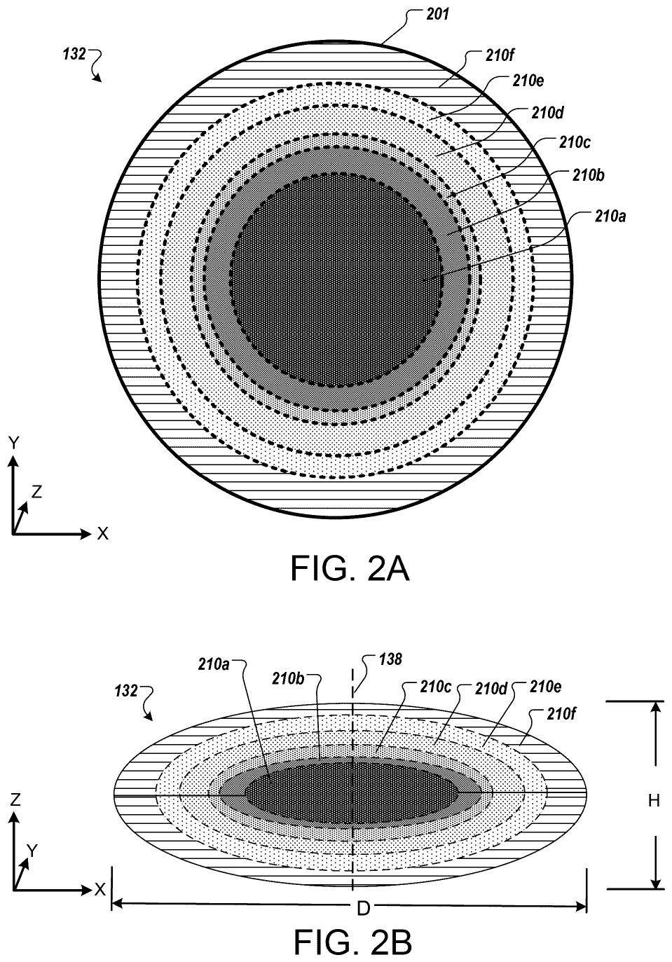

FIG. 2A is a top view of an example of the lens 132, looking down along the central axis 138. FIG. 2A shows that the lens 132 as a whole has a circular shape at the outer perimeter 201 (e.g., in a horizontal or XY plane). As an example, the lens 132 may have a diameter of approximately 6 inches. More generally, in some implementations, the diameter of the lens 132 is in the range of 2 to 24 inches, or the range of 3 to 12 inches, or the range of 4 to 8 inches.

The lens 132 has a substantially ellipsoidal or spheroidal shape, e.g., a three-dimensional volume resulting from rotating an ellipse or oval. In some implementations, the lens 132 may be substantially spherical. Nevertheless, it can be beneficial for the lens 132 to have a flattened or compressed dimension along the Z axis to reduce the overall volume of the lens system 131 and the terminal 130 as a whole. For example, the height H of the lens 132 may be one half or less of the diameter D of the lens 132 (see FIG. 2A). As additional examples, the height H may be one fourth, one sixth, or one eighth the diameter D.

The lens 132 is formed of multiple components 210a-210f, e.g., different layers or shells, that are nested within each other. Each component 210a-210f or layer can have an ellipsoidal exterior shape. The components 210a-210f or layers can be formed of separately-molded components. For example, the component 210a can be molded as a single piece, and each of the other components 210b-210f can be molded as two or more pieces (e.g., separate top and bottom halves) with a recess or cavity to fit the other layers within. For example, the pieces that form component 210b can fit over the component 210a to form a first subassembly; the pieces that form component 210c can fit over the first subassembly to form a second subassembly; the pieces that form component 210d fit over the second subassembly to form a third subassembly; and so on. Together, the nested ellipsoidal shells provide the gradient in dielectric constant that is desired for the lens 132. The illustrated example includes six layers or shells, e.g., six distinct regions of different refractive indices or different dielectric constants. More or fewer layers or shells can be used depending on the application.

The different components 210a-210f have different dielectric constants to provide, or at least approximate, a dielectric constant gradient through the lens 132. The refractive index decreases from the interior to the exterior of the lens 132. For example, the component 210a has the highest dielectric constant and component 210f has the lowest dielectric constant. In some implementations, the dielectric constants of the components 210a-210f range from approximately 12 for the inner component 210a to approximately 2 for the outer component 210f. This provides a gradient that, at the exterior, is close to the dielectric constant of the environment. In some implementations, the dielectric constant of the outer component 210f can be even lower, such as a value of approximately 1.

The geometry and permittivity distribution of the lens 132 re-shape incident electromagnetic radiation. The different dielectric constants of the components 210a-210f implement the refraction that reshapes a substantially spherical wavefront, which emanates from the phased array 134 and is incident to the bottom of the lens 132, into a directed planar wavefront transmitted at the top of the lens 132.

As discussed above, the components 210a-210f can be molded components formed of PPE, PEEK, PPC, or another polymer material. The different dielectric constants of the components 210a-210f can be achieved by using different polymer formulations for different components 210a-210f, such as by using different densities of material to provide different dielectric constants. Typically, a higher density of the polymer results in a higher dielectric constant. As additional examples, different components 210a-210f can be formed using different blends of materials and/or different types or categories of polymers. The example of FIG. 2A has dielectric constants as shown in Table 1 below:

TABLE 1

| Component | Dielectric constant |
|---|---|
| Component 210a | 11.3 |
| Component 210b | 8.2 |
| Component 210c | 7.1 |
| Component 210d | 6.8 |
| Component 210e | 5.3 |
| Component 210f | 2.6 |

Features of the lens 132 are also shown in FIG. 2B, which shows a side view of the lens 132. The components 210a-210f can be formed as shells that form nested ellipsoidal shapes. The inner component 210a can be formed of a single ellipsoid. The other components 210a-210f can be formed in two pieces that each fit over and enclose the other components within. For example, the component 210b can be formed as a shell having two pieces, one for the top and one for the bottom, that close around the inner component 210a to cover it. Similarly, the component 210c can be formed in two pieces that close around the subassembly of components 210a, 210b, and the other components 210d-210f can similarly close over the other pieces to form the lens 132.

As another example, the lens 132 can be formed of 5 different components with spheroid profiles, where the components have diameters perpendicular to the central axis 138 of 5.6 inches, 4.2 inches, 3.0 inches, 1.8 inches, and 1.2 inches, respectively, from the outer layer to the inner layer. In this example, the distance between the exterior surface of the lens 132 to the center of the lens 132 measured along the central axis 138 can be 1.4 inches, so that the height H is approximately 50% of the diameter D (e.g., 2.8 inches/5.6 inches=50%).

As discussed above, the lens 132 can be formed using plastic injection molding. For example, one method of manufacturing the lens 132 can include molding the components 210a-210f separately, to form the layers or shells separately in molds and then attach the components 210a-210f together. For example, the center component 210a can be formed by injection molding as a single piece. The other components 210a-210f can each be formed by plastic injection molding as two or more pieces each (e.g., with each component 210b-210f having a separately molded top and bottom piece). After the components 210a-210f are formed, the components 210a-210f can then be bonded together in a process similar to circuit board lamination, in which a “prepreg” material (e.g., a matrix pre-impregnated with resin, where the matrix can be a fabric, mesh, or other material) or pressure-sensitive adhesive are placed between the molded components 210a-210f and the assembly as a whole is placed in a fixture in a hot press to bond the assembly together. Creating a low-profile spheroid lens 132 using injection molding allows the use of low-loss materials and allows high manufacturing precision, resulting in excellent antenna performance.

As another example, the components can be made by overmolding the components 210a-210f on top of each other. For example, a mold can be machined to provide the general shape the first component 210a. Once the first component 210a is cured, the outer surface of the first component 210a can be smoothed or machined, if needed, to form a surface over which the material of the second component 210b can be formed. The prepared first component 210a can be placed in the center of a second mold, and the space between the first component 210a and the interior of the second mold can be filled with resin to form the second component 210b around the first component 210a. In this manner, the components 210a-210f can be built up successively around the inner components using increasingly larger ellipsoidal molds.

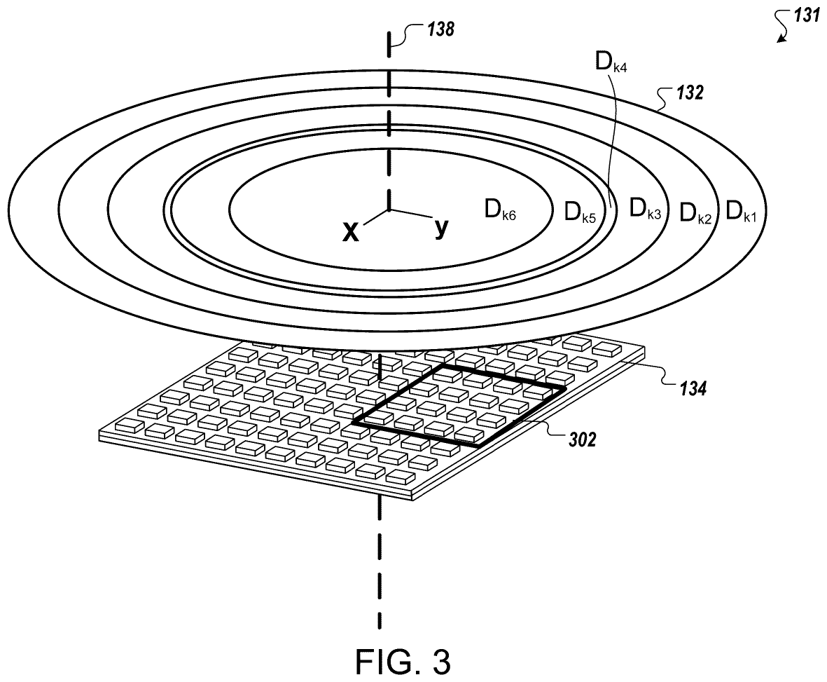

FIG. 3 shows another view of the antenna system 131, with the lens 132 and the phased array 134 illustrated. In the example, the phased array 134 includes a 10×10 array of antenna elements, for a total of 100 antenna elements. These antenna elements are separately addressable by the processing system 171, so that that processing system 171 can selectively activate the different antenna elements to produce the combinations of activations, with differing phase characteristics, to produce the desired excitation pattern 135. In the example of FIG. 3, selected set of antenna elements 302 is activated, e.g., a 4×4 subset of the antenna elements of the phased array 134 at the edge of the phased array 134. the selected set of antenna elements 302 is excited with phase differences to create a spherical wavefront that emulates the spherical fields that would be produced a horn or patch antenna in the same region. By changing the positions of the excited antenna elements, and by changing the magnitudes and phases of excitation, a resulting beam above the lens 132 can be scanned continuously in two axes (e.g., in an azimuth angle around the central axis 138 and along an elevation angle toward or away from the central axis 138).

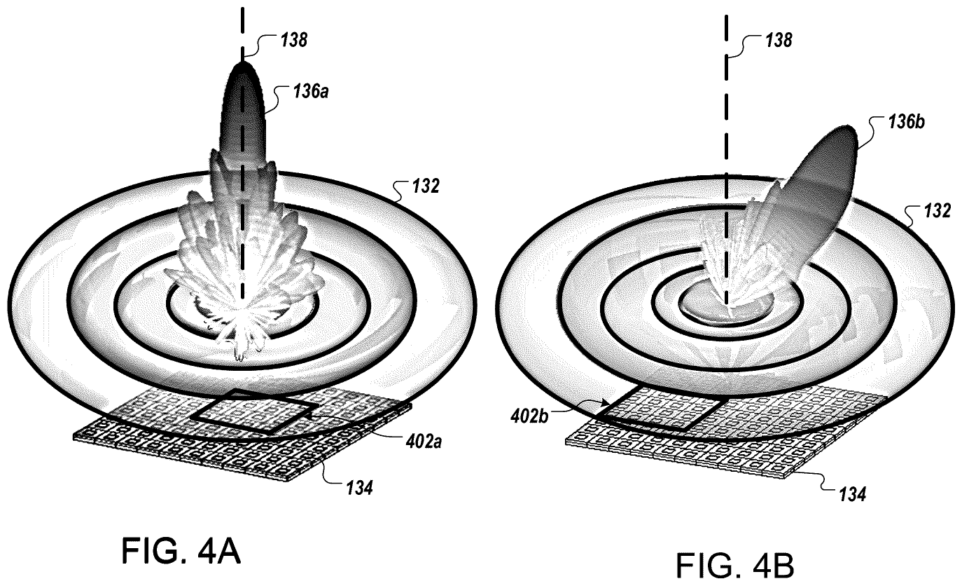

FIGS. 4A and 4B are examples showing how activating different sections of the phased array 134 affects the resulting beam. For example, in FIG. 4A, a first set of elements 402a in the center of the phased array 134 is energized, which results in a beam 136a centered on the central axis 138. For this beam direction, magnitude and phase of excitation of the antenna elements in the set 402a are optimized to provide maximum gain at the boresight (e.g., along the central axis 138). In some implementations, a lens of approximately six inches can achieves an efficiency of 50% or more. In FIG. 4B, a second set of antenna elements 402b on the right side of the phased array 134 is energized, and the resulting beam 136b is angled to the left at about a 37° elevation angle with respect to the horizontal plane. The antenna elements in the set 402b are optimized with the objective achieve low scan loss and low side lobes.

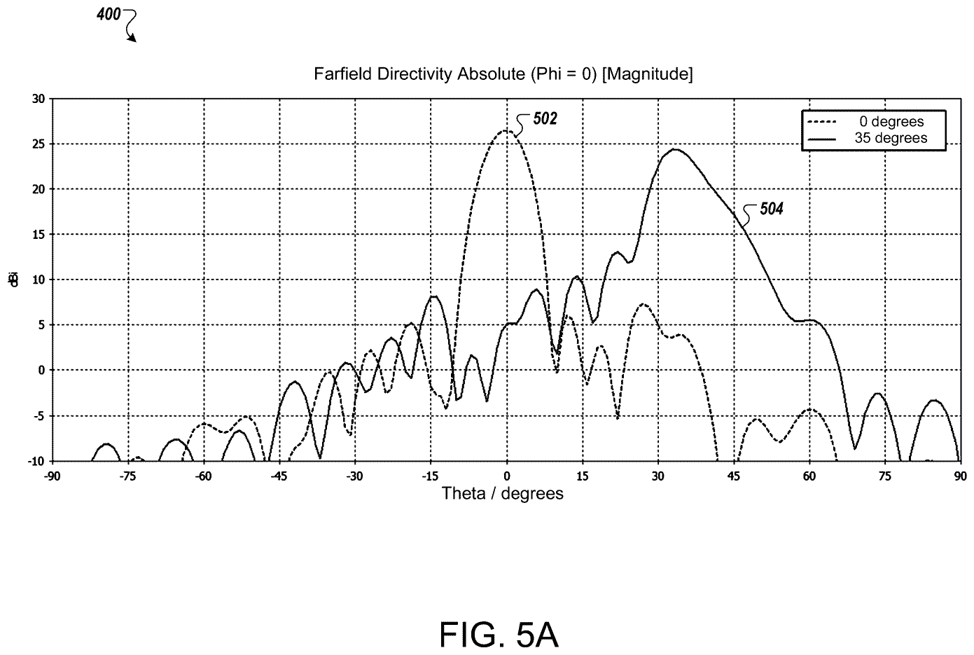

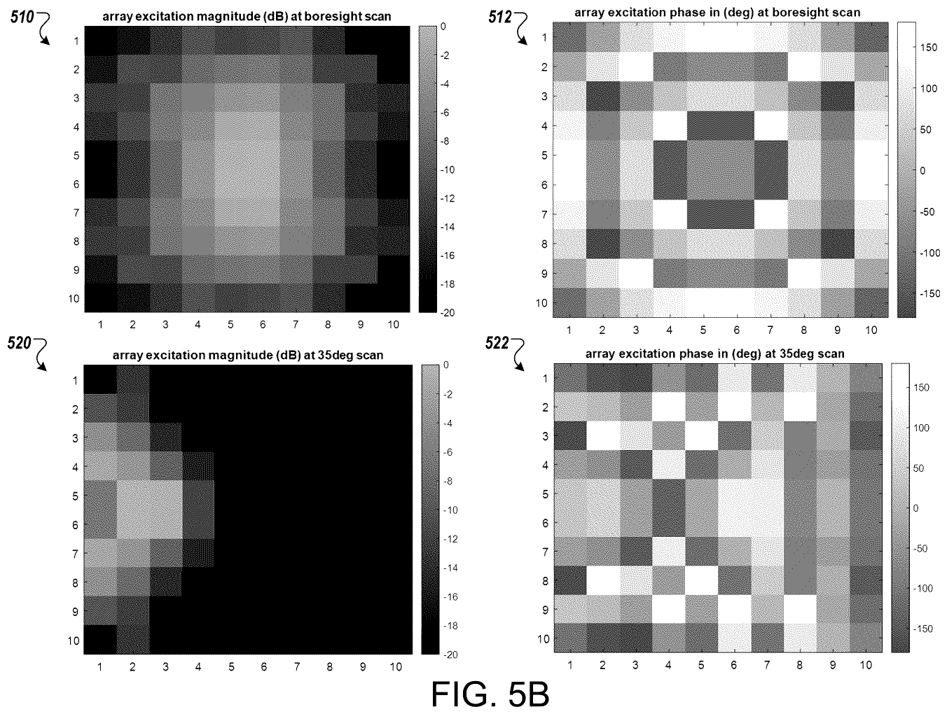

FIG. 5A is a graph that shows directivity for two different angled scan patterns. The differences in the directivity show how different excitation characteristics for the phased array 134 can change the spatial response of the antenna system 131. A first line 502 shows directivity of a beam from the antenna system 131 with a 0-degree or boresight scan pattern. A second line 504 shows directivity of a beam for an approximately 35-degree scan pattern.

FIG. 5B shows examples of excitation magnitudes and excitation phase for creating the scan patterns of FIG. 5A. These examples use a phased array 134 as a 10-by-10 rectangular grid of antenna elements, for a total of 100 antenna elements. These excitation patterns are designed for operation at approximately 19 GHZ, an appropriate excitation patterns can be determined for other operating frequencies or frequency bands if desired.

The chart 510 shows array excitation magnitude, on a decibel (dB) scale, for a 0-degree or boresight scan. The highest magnitude of excitation is located at the central antenna elements, and the excitation magnitude tapers off toward the edges of the phased array 134. The graph 512 shows array excitation phase in degrees for the 0-degree or boresight scan.

The chart 520 shows array excitation magnitude, on a decibel (dB) scale, for a 35-degree scan. The excitations are located mainly at the left edge of the phased array 134 which will direct the resulting beam to the right side. The graph 522 shows array excitation phase in degrees for the 35-degree scan.

As discussed above, the processing system 171 can access stored data, such as in the lookup table 176, that specifies excitation patterns, including magnitude and phase for the various antenna elements of the phased array 134 for each of various different scan patterns or beam positions. The examples of FIG. 5B show just two of potentially hundreds or thousands of different excitation patterns that can be pre-computed and stored, and then retrieved to place beams in desired locations.

In general, it is desirable to excite many antenna elements of the phased array 134 concurrently, so the total output power of the antenna system 131 is large. For example, in some cases, various excitation patterns may concurrently activate, for example, one eighth, one fourth, one third, or one half of the antenna elements in the phased array 134 for individual excitation patterns. In some implementations, such as where the phased array 134 does not cover both sides of the lens 132 and is rotated to an appropriate position, more than half or even all of the antenna elements of the phased array 134 may be excited to achieve certain excitation patterns.

Using the phased array 134 to feed the lens antenna comprising the lens 132 allows the phased array 134 to emulate spherical wavefront that would emanate from a horn or patch antenna located at any of a continuous range of points behind the lens 132. This results in the ability to direct a beam from the lens in a full, continuous scan volume, not just a few fixed directions. With discrete feeds, such as a horn or path, only as many different beams (e.g., scan directions) may be formed as there are separate feeds. Antennas with discrete feed antennas do not cover a continuum of scan angles but only a discrete subset.

Another advantage of using phased array feed, as compared to discrete feed, is that it allows for the simultaneous excitation of multiple active feed elements. This results in an increase in the effective isotropic radiated power (EIRP). In practice, a larger EIRP enhances transmission data rates in the communication system. Otherwise, the system will need a separate high-power input to reach the same level of EIRP using the discrete feed.

FIG. 6 is a diagram that shows example relationships between an example lens 132 and phased array 134b. The example of FIG. 6 shows side views of the lens 132 and phased array 134b. The lens 132b has a diameter, D, and the phased array 134 has a width, W, with both being measured perpendicular to the central axis 138. In this example, the phased array 134b is square, and the width W represents the distance along one side of the square profile of the phased array 134b.

The sides of the phased array 134b, e.g., the width, W, can be approximately half the size of the diameter, D, of the lens. This is smaller than many previous designs, which often include phased arrays with widths of 75% or more of the lens diameter. In the antenna system 131, the size of the phased array 134b is reduced while still maintaining the lens scanning capability to electrically scan a beam from the central axis 138 downward by at least 30° from the central axis 138 (e.g., to an elevation of 60° or less). The advantages of using a smaller array 134b include reduced overall cost associated with the circuit board, such as by allowing the use of fewer excitable antenna elements, a simpler beamforming network, and a smaller circuit board size. The phased array 134b is, for example, smaller relative to the diameter D than the version of the phased array 134 shown in FIG. 3.

A compact phased array size can be achieved by limiting the condensed field area, which emits collimated wave after passing through the lens within the beam-steering range. This can be accomplished by the controlling the lens compression factor and adjusting the distance between the array and the lens. For example, the excitation plots of FIG. 5B show relatively light regions in the charts 510, 520 of excitation magnitude, and these areas representing the concentrated field that should remain within the array's full range, particular when the beam scans to its maximum angle. The combination of compressing the shape of the lens 132 (e.g., to have a height approximately one half of the diameter, D), as well as spacing the phased array 134 from the lens center, allows the phased array 134 to generate spherical wavefronts that simulate output of a horn or patch at a wide range of positions below the lens 132, with a much smaller phased array 134 than would be needed otherwise.

The phased array 134 is spaced apart from the center of lens 132 along the axis 138 by a distance X. Similarly, the bottom surface of the lens 132 can be spaced apart from the phased array 134 by a distance Y. In some implementations, the distance X is between approximately one third of the diameter D to three quarters of the diameter D. As another example, the distance Y may be between approximately 0% and approximately 50% of the diameter D, or may be between approximately 10% and approximately 40% of the diameter D. The width W of the phased array 132 may be approximately 70%, 60%, 50%, 40%, or a lower percentage of the diameter D of the lens 132. As an example, the width W may be between 40% and 60% of the diameter D.

As another example, the phased array 134 may have a maximum width in the plane perpendicular to the central axis 138 (e.g., along a diagonal of the square shape of the phased array 134) that is less than the diameter D of the lens 132. For example, for a width W that is approximately 50% of the diameter D, the maximum width of the phased array in the plane can be approximately 71% of the diameter D. In some implementations, the maximum width of the phased array 124 in the plane perpendicular to the central axis 138 can be between 80% and 40% of the diameter D.

As another example, the phased array 134 may have antenna elements that are arranged to cover an area that is a fraction of the maximum area of the lens 132 perpendicular to the central axis 138. For example, for a width W that is approximately 50% of the diameter D, the area covered by the phased array 134, measured in a plane perpendicular to the central axis 138, can be approximately one third of the maximum area of the lens 132 perpendicular to the central axis 138. In some implementations, the area of the phased array 134 is between 20% and 50% of the area of the maximum profile or footprint of the lens 132 (e.g., a plane through the center of the lens 132 that is perpendicular to the central axis 138), for example, one half, one third, one quarter, etc.

In general, the relative dimensions of the phased array 134 and the lens 132 may vary depending on, for example, the shape of the phased array 134 (e.g., square, circular, etc.), the range of elevation coverage needed, the distances X and Y between the phased array 134 and the lens 132 along the central axis 138, and so on.

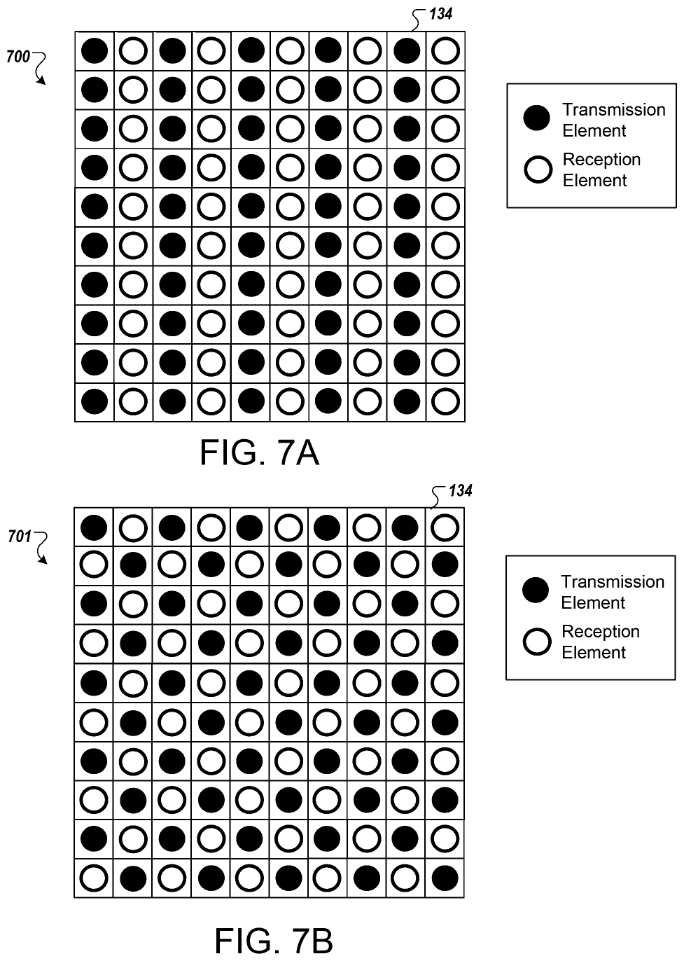

FIGS. 7A and 7B illustrate examples of antenna element distributions in a phased array. FIG. 7A shows a first arrangement 700 of antenna elements that can be used in the phased array 132, where rows or columns of transmission elements are interspersed with rows or columns of reception elements. Including both transmission elements and reception elements enables concurrent data transmission and data reception (e.g., duplex operation) using the single antenna system 131. For transmitting data, only the transmission elements would be excited, and the excitation pattern would be designed for the layout of transmission elements shown. For receiving data, reception elements can be configured with magnitude and phase separate from the control of the transmission elements, so that received signals are processed to achieve a spatially-directed reception response. The phased array 132 can be used to transmit and receive simultaneously (e.g., full-duplex mode) or in a different time frame (e.g., half-duplex mode) depending on the system requirements.

FIG. 7B shows second arrangement 701 of antenna elements that can be used in the phased array 132. Instead of having rows or columns that alternate between transmission elements or reception elements, the transmission elements or reception elements are interspersed in the rows and columns, resulting in a checkerboard pattern of the two types of antenna elements.

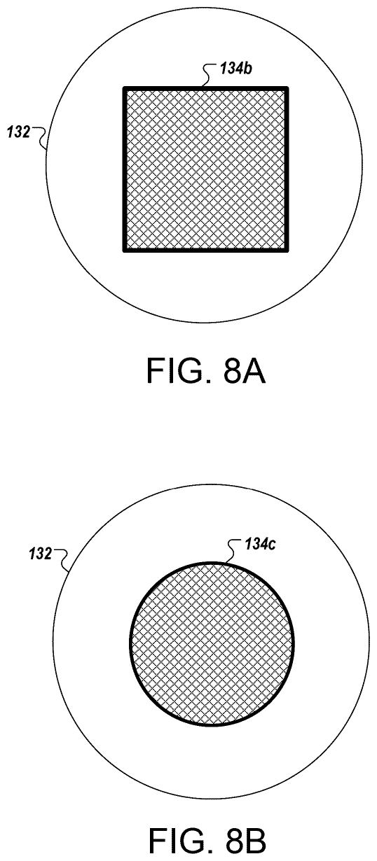

FIGS. 8A and 8B show examples of different sizes and shapes of phased arrays with respect to the lens 132. For example, FIG. 8A shows the phased array 134b, which has a square shape with sides having a width that is approximately one half of the diameter of the lens 132 (e.g., between 40% and 60% of the diameter, between 45% and 55% of the diameter, etc.). FIG. 8B shows another example phased array 134c, which has a substantially circular shape with a diameter that is approximately half of the diameter of the lens 132 (e.g., between 40% and 60% of the diameter, between 45% and 55% of the diameter, etc.).

FIG. 9A is a diagram showing a side view of an example phased array 934 and a motorized mount 910 configured to rotate the phased array 934 in a plane around the central axis 138 to change its position relative to the lens 132. This can have the benefit of further reducing the aperture size of the feeding array.

The mount 910 includes a one-axis rotator and is configured to rotate the phased array 934 as controlled by the processing system 171. The azimuth beam direction can be managed by a mechanical rotation powered by a motor in the mount 910, while control of the elevation beam direction is set through a designed array excitation. The primary advantage of adopting this method is the significant reduction in the array aperture size by approximately 50 percent. In a larger phased array 134, most of excitation energy for a given beam orientation is centered on a selected portion of phased array 1, and the remaining array portion may have considerably lower amount of excitation energy in comparison. In other words, if a phased array 134 covers the entire area where source wavefronts would be generated for the full range of beam orientations, excitation energy for any single beam orientation is often relatively concentrated among a fraction of the area of the overall phased array 134 (or a subset of the antenna elements). As a result, the contribution of much of the phased array 134 to the beam formation at any given time is typically limited.

By transferring the azimuth scan function to the motorized mount 910, instead of to placement of excitations along the phased array 134, the phased array 934 of FIG. 9 can be much smaller while without reducing the size of the volume through which the beam can be scanned. For example, the phased array 934 can be half of a full phased array 132 (e.g., only one side), and can be rotated to place the array 934 at the position around the axis 138 where excitation is needed. In some implementations, the phased array 934 is required to scan about half of the full range on the elevation plane as would be needed for the phased array 134.

In this arrangement, lens 132 remains stationary, while the phased array 934 located below the lens 132 rests on the one-axis rotator of the mount 910. The phased array 934 is positioned asymmetrically with respect to the axis of rotation, which in the example is the central axis 138. As a result, the antenna elements of the phased array 934 cover a larger area at a first side of the axis of rotation than at a second side that is opposite the first side. The phased array 934 is arranged so that rotating the phased array 934 changes where the largest area of antenna elements is located with respect to the lens 132.

As an example, with the array 934 rotated to the right side, excitation of the phased array 934 on the right side generates a beam 930 directed towards the upper-left side. After the processing system 171 instructs the mount 910 to make a 180° rotation of the circuit board of the array 934 on the azimuth plane, using the same array excitation will form a beam 932 in the upper-right direction.

FIGS. 9B-91 are diagrams that illustrate examples of different shapes and sizes of phased arrays with respect to the lens 132. Many different sizes and shapes of phased arrays can be used, allowing for larger or smaller areas or numbers of antenna elements to adjust cost and antenna aperture. In these examples the phased array is attached to the motorized mount 910 at, and is rotated about, an axis of rotation that coincides with the central axis 138 of the lens 132.

FIGS. 9B-9E show examples where the phased array has a dimension that extends substantially to the edge of the diameter D of the lens 132. FIG. 9B shows a phased array 934b that has square shape that is rotated from a corner. FIG. 9C shows a phased array 934c that has a circular shape that is rotated from an edge of the circle. FIG. 9D shows an example of a phased array 934d having a rectangular shape that is rotated from a point along a side of the rectangle. FIG. 9E shows an example of a phased array 934e that is shaped substantially as a sector of the overall circle that is the outer perimeter of the lens 132.

FIGS. 9F-91 show additional examples of phased arrays 934f-934i, where the phased arrays have the same shapes as the phased arrays 934b-934e. However, the phased arrays 934f-934i are smaller and do not extend to the exterior perimeter of the lens 132. It is often beneficial to reduce the size of the array, and this can be appropriate when, as discussed with respect to FIG. 6, each phased array 934b-934e is spaced apart from the lens 132 along the central axis 138, which allows the array size to be reduced, although it may reduce the range of elevation (e.g., altitude) that can be achieved.

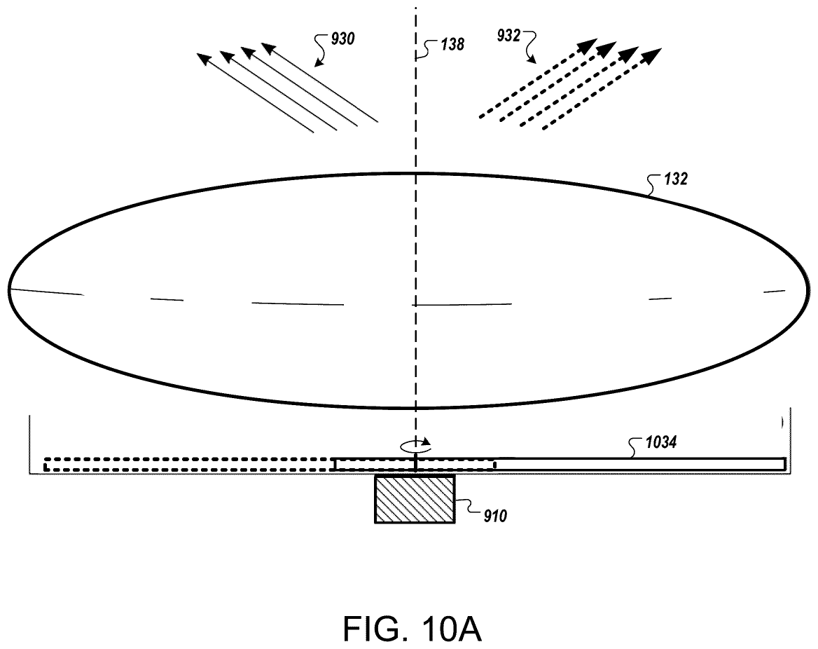

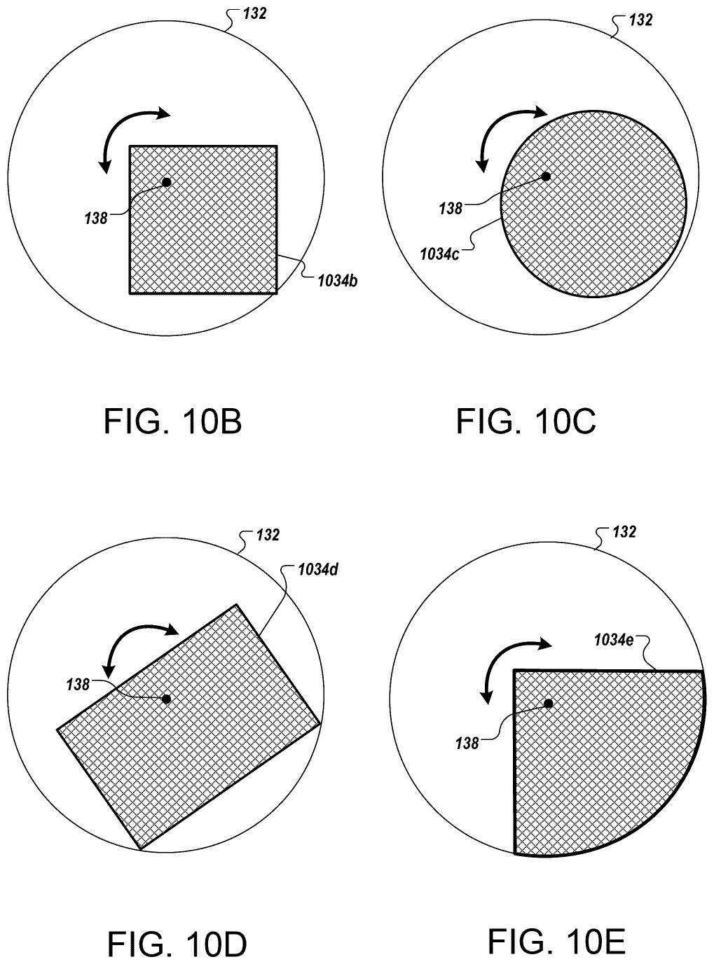

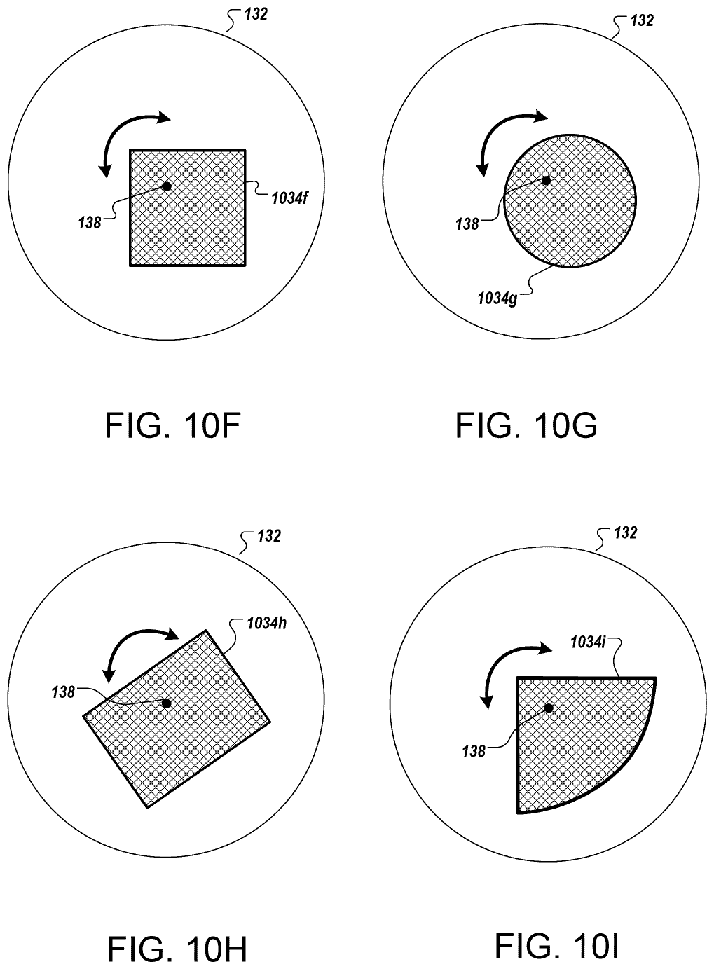

FIG. 10A is diagram showing a side view of another example phased array 1034 and a motorized mount 910 configured to rotate the phased array 1034 to change its position relative to the lens antenna 132. This example has features as described for FIG. 9A, except that instead of attaching to the rotor at the edge of the phased array 1034, the phased array 1034 is connected so that the phased array 1034 extends past the rotor to the opposite side.

To achieve a high-quality beam along the central axis 138, antenna elements often need to be excited from positions around the central axis 138, not just from one side. In the example of FIG. 9A, the phased array 934 does not extend to place antenna elements on opposite sides of the central axis 138 and the antenna elements do not extend to surround the central axis 138. As a result, the beam orientation that is achievable may be limited to no closer than, for example, 10, 20, or 30 degrees from central axis 138. This may be acceptable for use in a satellite terminal communicating with GEO satellites, because the satellite will not be located directly overhead. Nevertheless, for applications where higher beam orientations are desired, potentially up to the central axis 138 itself, it can be beneficial to place antenna elements surrounding the central axis 138 or with antenna elements on opposing sides of the central axis 138.

FIGS. 10B-101 are diagrams that illustrate examples of different shapes and sizes of phased arrays that can be used. The phased arrays 1034b-1034i have shapes and sizes similar to those of FIGS. 9B-9i, but the phased arrays 1034b-1034i are each coupled to the motorized mount 910 at a location on the interior of the phased arrays 1034b-1034i instead of at the edge or perimeter. This increases the angular range of scanning, especially toward or including the orientation of the central axis 138, while still allowing a much smaller array than would be needed without the rotation provided by the motorized mount 910.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

1. A communication device comprising:
an antenna system comprising:
a gradient index lens having a substantially oblate ellipsoidal shape, wherein the gradient index lens has a diameter and a central axis substantially perpendicular to the diameter, the gradient index lens having a plurality of layers that respectively have different dielectric constants, the layers being arranged to provide a progressively decreasing dielectric constant from an inner layer to an outer layer of the gradient index lens; and
a feed antenna comprising a substantially planar array of antenna elements;
wherein the feed antenna is spaced apart from the gradient index lens along the central axis; and
one or more processors configured to control excitation patterns for the antenna elements of the feed antenna to cause beams from the gradient index lens to be directed at any of a range of spatial locations, wherein the one or more processors are configured to cause the antenna elements to be excited with excitation patterns that concurrently excite multiple antenna elements of the feed antenna with different magnitudes and phase characteristics.

2. The communication device of claim 1, wherein the plurality of layers of the gradient index lens comprise nested ellipsoidal shells formed of polymer materials.

3. The communication device of claim 1, wherein the layers are formed of at least one of polyphenylene ether (PPE), polyether ether ketone (PEEK), or polypropylene copolymer (PPC).

4. The communication device of claim 1, wherein the layers are formed of separately-molded components, wherein different layers are formed of different densities of polymer material.

5. The communication device of claim 1, wherein the layers are formed of separately-molded components, wherein different layers are formed of different densities of polymer material.

6. The communication device of claim 5, wherein the layers are bonded together using a bonding agent.

7. The communication device of claim 6, wherein the bonding agent comprises a pressure-sensitive adhesive or a matrix pre-impregnated with resin.

8. The communication device of claim 1, wherein the communication device is a very small aperture terminal (VSAT) for communication in a satellite communication system, and wherein the one or more processors are configured to adjust the excitation patterns for the feed antenna to detect or track a position of a satellite.

9. The communication device of claim 1, wherein the communication device is configured to sweep a beam from the antenna system from a range of elevation from the central axis to an elevation from a horizontal plane of 30 degrees or less by changing the excitation pattern applied to the antenna elements in the array of the feed antenna.

10. The communication device of claim 1, wherein the communication device is configured to sweep a beam 360 degrees about the central axis by changing the excitation pattern applied to the antenna elements in the array of the feed antenna.

11. The communication device of claim 1, further comprising a motorized mount configured rotate the array of the feed antenna about an axis of rotation, to rotate the array in a plane substantially perpendicular to the central axis,
wherein the array is positioned asymmetrically with respect to the axis of rotation, and wherein the array is rotatable around the axis of rotation to change an azimuth of beams from the gradient index lens.

12. The communication device of claim 1, wherein the lens has a height along the central axis that is between 40% and 60% of the diameter of the lens.

13. The communication device of claim 1, wherein the array has a maximum width measured in a plane perpendicular to the central axis, and the maximum width is between 20% and 80% of the diameter of the lens.

14. The communication device of claim 1, wherein the lens has a bottom surface that faces toward the array, and wherein the array is spaced apart from the bottom surface of the lens along the central axis by a distance that is up to 50% of the diameter of the lens.

15. The communication device of claim 1, comprising a data storage device storing a lookup table that specifies magnitude and phase characteristics for excitation patterns that, when applied to the array, respectively provide different beam orientations;
wherein the one or more processors are configured to (i) retrieve data from the lookup table that specifies an excitation pattern for a desired beam orientation and (ii) cause the antenna elements to be excited with the excitation pattern for the desired beam orientation.

16. A method of creating a gradient index lens, the method comprising:
molding a plurality of components that are sized to fit together to provide a series of layers, wherein the layers are respectively formed of materials with different dielectric constants such that different layers have different dielectric constants;
fitting the components together to form an assembly, wherein the components are arranged in the assembly such that the layers decrease in dielectric constant from an inner layer of the assembly to an outer layer of the assembly; and
bonding the components of the assembly together to form a gradient index lens having a substantially ellipsoidal shape.

17. The method of claim 16, wherein molding the plurality of components comprises forming the components by injection molding.

18. The method of claim 16, wherein fitting the components together comprises nesting the components together.

19. The method of claim 16, wherein the components are formed of at least one of polyphenylene ether (PPE), polyether ether ketone (PEEK), or polypropylene copolymer (PPC).

20. The method of claim 16, wherein bonding the components of the assembly together comprises applying at least one of heat or pressure to the assembly.
